(19) United States
(12) Patent Application Publication
(10) Pub. No.: US 2024/0022114 A1
(43) Pub. Date: Jan. 18, 2024

(54) WIRELESS POWER TRANSMISSION SYSTEM

(71) Applicant: Murata Manufacturing Co., Ltd., Kyoto-fu (JP)

(72) Inventor: Hiromasa SAEKI, Nagaokakyo-shi (JP)

(73) Assignee: Murata Manufacturing Co., Ltd., Kyoto-fu (JP)

(21) Appl. No.: 18/362,692

(22) Filed: Jul. 31, 2023

Related U.S. Application Data
(63) Continuation of application No. PCT/JP2021/039282, filed on Oct. 25, 2021.

(30) Foreign Application Priority Data
Feb. 2, 2021 (JP) 2021-014963

(51) Int. Cl. H02J 50/00; H02J 50/20

(52) U.S. Cl. CPC H02J 50/005; H02J 50/20

(57) ABSTRACT

A wireless power transmission system includes a structure entirely surrounded by an electromagnetic wave shielding member having appropriate conductivity, at least one power transmission unit and at least one power reception unit. The power reception unit is composed of a power receiver including, for example, a power reception antenna wiring line and a rectifier circuit. The power reception antenna wiring line has a wiring structure of two lines which are formed in the same plane and each of which has one end connected to the rectifier circuit, the other ends thereof being open ends which face each other, and the power reception antenna wiring line has a plurality of bent portions in the above wiring structure.

### CROSS-REFERENCE TO RELATED APPLICATIONS

This application claims benefit of priority to International Patent Application No. PCT/JP2021/039282, filed Oct. 25, 2022, and to Japanese Patent Application No. 2021-014963, filed Feb. 2, 2021, the entire contents of each are incorporated herein by reference.

### BACKGROUND

### Technical Field

The present disclosure relates to a wireless power transmission system. More specifically, the present disclosure relates to a wireless power transmission system in which a power transmitter for transmitting radio-frequency electromagnetic waves is used. The wireless power transmission system of the present disclosure relates to a structure and an electronic apparatus for increasing a degree of freedom in installation orientation of a power receiver when wireless power is supplied with high power transmission efficiency to a device or the like disposed in a space surrounded by wall surfaces, such as an inside of a warehouse, an inside of a factory or an inside of a vehicle.

### Background Art

In recent years, with an explosive increase in the number of IOT (Internet of Things) devices, a problem arises in a power supply method to these devices. Wiring connection to a huge number of devices is difficult, and there is a problem in that when a battery is used as a power source, much labor is required to replace a consumed battery. In order to solve these problems, a technique for wirelessly transmitting power is expected.

H. Mei, K. A. Thanckston, R. A. Bercich, J. G. R. Jefferys, and P. P. Irazoqui, “Cavity Resonator Wireless Power Transfer System for Freely Moving Animal Experiments,” IEEE Biomed. Eng., Vol. 64, No. 4, pp. 775 to 785 June 2016 (Non Patent Document 1) discloses a wireless power transmission system in which, an inside of a space surrounded by metal is regarded as a resonator, an electromagnetic wave is radiated from a power transmission unit at a resonant frequency unique to the resonator, and power is transmitted to a power receiver in the resonator. At this time, wireless power transmission is achieved by mounting a monopole type power transmission antenna and two orthogonal coil-shaped antennas. According to the author of Non Patent Document 1, a contrivance is made to enable reception of electromagnetic waves from different orientations by orthogonally disposing the two coil antennas.

Similarly to Non Patent Document 1, Japanese Unexamined Patent Application Publication No. 2020-089209 discloses a wireless power transmission system in which, an inside of a space surrounded by metal is regarded as a resonator, an electromagnetic wave is radiated from a power transmission unit at a resonant frequency unique to the resonator, and power is transmitted to a power receiver in the resonator. Japanese Unexamined Patent Application Publication No. 2020-089209 discloses a power receiver having a structure in which a first power receiver and a second power receiver are disposed so as to be parallel and face each other, and are connected to each other by a conductor column. It is explained that the structure enables power to be transmitted to a power reception unit with high efficiency even when visibility between a power transmission unit and the power reception unit is poor.

S. Rahimizadeh, S. Korhummel, B. Kaslon, Z. Popovic, “Scalable adaptive wireless powering of multiple electronic devices in an over-moded cavity,” Conference Paper: Wireless Power Transfer (WPT), 2013 IEEE (Non Patent Document 2) discloses a wireless power transmission system in which, an inside of a space surrounded by metal is regarded as a resonator, an electromagnetic wave is radiated from a power transmission unit at a resonant frequency unique to the resonator, and power is transmitted to a power receiver in the resonator. In Non Patent Document 2, wireless power transmission is achieved by using a power transmission antenna in which two patch antennas each formed on a printed circuit board are prepared, and are respectively disposed on opposite surfaces of the resonator so as to be orthogonal to each other. The author of Non Patent Document 2 points out that this antenna operates only in a hollow resonator. That is, it is pointed out that in the power transmission using a resonance phenomenon in the resonator, power transmission of electromagnetic waves is performed based on a principle different from that of a general antenna used in an open space.

### SUMMARY

In a wireless power transmission system in which, an inside of a space surrounded by metal is regarded as a resonator, power is transmitted at a resonant frequency unique to the resonator, design of an appropriate power transmission/reception antenna in which a thin power receiver is used and the power receiver can have a high degree of freedom in installation is not clear in an existing method.

In the case of the method described in Non Patent Document 1, a method is disclosed in which a power transmitter in which one monopole antenna is used and a power receiver in which two coil antennas orthogonal to each other are used are used, to increase a degree of freedom in disposition of the power receiver in which power reception is allowed. Such a feature that a degree of freedom in power receiving orientation is high is desirable from the viewpoint of utilization in an IOT device. On the other hand, since coil antennas respectively having diameters of 7 mm and 5 mm are configured to be disposed so as to be orthogonal to each other, there is a problem that the power receiver becomes three dimensional in shape, and is too thick to be mounted to the IOT device.

In the case of the method described in Japanese Unexamined Patent Application Publication No. 2020-089209, a structure of the power receiver is disclosed in which the first power receiver and the second power receiver are disposed so as to be parallel and face each other and are connected to each other by the conductor column. Since there is no description about orientation in which electric power can be received in the literature, the orientation in which electric power can be received is not clarified, and no contrivance is made to enhance the orientation in which electric power can be received. In addition, since the first and second power receivers are three dimensionally disposed, there is a problem that the first and second power receivers are too thick to be mounted to the IOT device.

In the case of the method described in Non Patent Document 2, one power transmission antenna is provided on each of the opposite two surfaces of the resonator. However, this means that two power transmission circuits are required, which makes the method expensive in practical use. Further, in the literature, there is no detailed description about a power receiving circuit, and an appropriate antenna design is not clarified in the first place. In addition, although it is pointed out that the power transmission/reception antenna operates only in the resonator and does not operate in an open space, it is not clarified under what conditions the antenna operates in the resonator.

The present disclosure provides a wireless power transmission system in which a power receiver is thin and has a high degree of freedom in installation orientation.

In a first aspect, a wireless power transmission system of the present disclosure includes a structure entirely surrounded by an electromagnetic wave shielding member having appropriate conductivity, at least one power transmission unit, and at least one power reception unit. The power reception unit is composed of a power receiver including a power reception antenna wiring line and a rectifier circuit. The power reception antenna wiring line has a wiring structure of two lines which are formed in the same plane and each of which has one end connected to the rectifier circuit and another end different from the one end connected to the rectifier circuit, the other ends thereof being open ends disposed so as to face each other, or has a loop-shaped wiring structure of one line which is formed in the same plane and which has both ends connected to the rectifier circuit, and the power reception antenna wiring line has a plurality of bent portions in either wiring structure. When viewed in a direction perpendicular to a direction in which wiring sections divided by the bent portions extend, in three or more pairs of wiring sections, the wiring sections of each pair face each other, and among the wiring sections facing each other, wiring portions with a longest facing portion are parallel to each other.

In a second aspect, a wireless power transmission system of the present disclosure includes a structure entirely surrounded by an electromagnetic wave shielding member having appropriate conductivity, at least one power transmission unit, and at least one power reception unit. The power transmission unit is composed of a power transmitter including a power transmission antenna mounting portion and a power transmission antenna wiring line. The power transmission antenna mounting portion is installed so as not to be electrically in contact with the electromagnetic wave shielding member. The power transmission antenna wiring line has a wiring structure which is formed inside the structure so as to be parallel to a wall surface made of the electromagnetic wave shielding member and which has one end electrically connected to the power transmission antenna mounting portion and another end that is an open end, and the power transmission antenna wiring line has four or more and eight or less (i.e., from four to eight) bent portions in the wiring structure. When viewed in a direction perpendicular to a direction in which wiring sections divided by the bent portions extend, a wiring section and another wiring section present on the same wiring line are parallel to each other at facing positions, and when observed along a path of the power transmission antenna wiring line from a connection portion with the power transmission antenna mounting portion to the open end, paths of the wiring sections parallel to each other at the facing positions are opposite to each other.

According to the present disclosure, it is possible to achieve a wireless power transmission system in which a power receiver is thin and has a high degree of freedom in installation orientation.

### BRIEF DESCRIPTION OF THE DRAWINGS

FIG. 1 is a configuration diagram of an example of a wireless power transmission system according to the present disclosure;

FIG. 2 is a schematic diagram of an example of a power transmission unit according to the present disclosure;

FIG. 3 is a schematic diagram of the power transmission antenna wiring line in the power transmission unit according to the present disclosure;

FIG. 4 is a schematic diagram of a power transmission antenna wiring line in the power transmission unit according to the present disclosure;

FIG. 5A is a schematic diagram before the power transmission antenna wiring line is rotated;

FIG. 5B is a schematic diagram after the power transmission antenna wiring line is rotated;

FIG. 6 is a schematic diagram of a power transmission antenna wiring line in the power transmission unit according to the present disclosure;

FIG. 7 is a schematic diagram of a power transmission antenna wiring line in the power transmission unit according to the present disclosure;

FIG. 8 is a schematic diagram of an example of a power reception unit according to the present disclosure;

FIG. 9 is a schematic diagram of the power reception unit including a power reception antenna wiring line;

FIG. 10 is a schematic diagram of the power reception unit including a power reception antenna wiring line;

FIG. 11 is a schematic diagram of the power reception unit including a power reception antenna wiring line;

FIG. 12 is a schematic diagram of a power transmission unit according to Example 1 of the present disclosure;

FIG. 13 is a schematic diagram of the power reception unit including a power reception antenna wiring line;

FIG. 14 is a graph showing a relationship between bandpass characteristics S21 and power reception antenna plane orientation and power reception antenna wiring orientation in a wireless power transmission system according to Example 1 of the present disclosure;

FIG. 15 is a graph showing a relationship between the bandpass characteristics S21 and power reception antenna plane orientation and power reception antenna wiring orientation in a wireless power transmission system according to Example 2 of the present disclosure;

FIG. 16 is a graph showing a relationship between the bandpass characteristics S21 and power reception antenna plane orientation and power reception antenna wiring orientation in a wireless power transmission system according to Example 5 of the present disclosure;

FIG. 17 is a schematic diagram illustrating a state in which the power transmission antenna wiring line is not rotated in a wireless power transmission system according to Example 6 of the present disclosure;

FIG. 18 is a schematic diagram illustrating a state in which the power transmission antenna wiring line is rotated in the wireless power transmission system according to Example 6 of the present disclosure;

FIG. 19 is a graph showing a relationship between the rotation angle of the power transmission antenna wiring line with respect to respective installation orientations of a power receiver and the bandpass characteristics S21 in the wireless power transmission system according to Example 6 of the present disclosure;

FIG. 20 is a graph showing a relationship between the average value of transmission power ratios in six directions shown in FIG. 19 and the rotation angle of the power transmission antenna wiring line;

FIG. 21 is a schematic diagram of an electric field intensity distribution in a wireless power transmission system according to Example 7 of the present disclosure; and

FIG. 22 is a graph showing a relationship between the relative position of a power reception unit and the bandpass characteristics S21 in the wireless power transmission system according to Example 7 of the present disclosure.

### DETAILED DESCRIPTION

Hereinafter, an embodiment of the present disclosure will be described with reference to the drawings.

In the present specification, terms indicating a relationship between elements (for example, “perpendicular”, “parallel”, “orthogonal”, and the like) and terms indicating a shape of an element are not expressions indicating only a strict meaning but expressions indicating inclusion of a substantially equivalent range, for example, a difference of about several %.

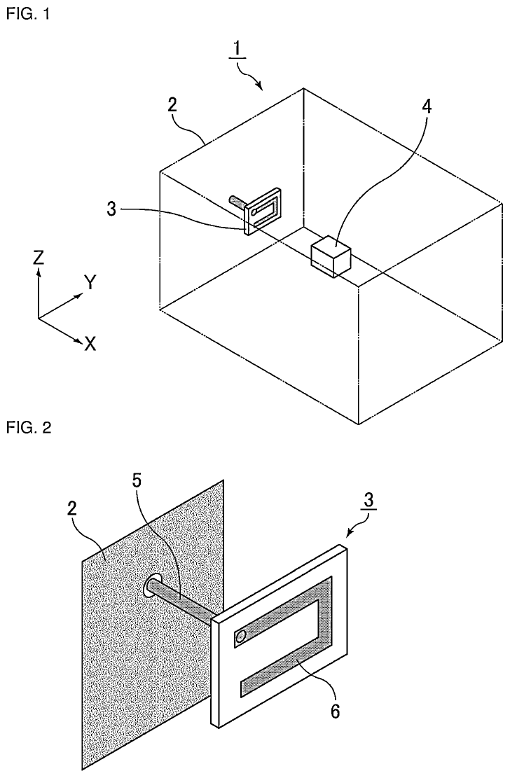

FIG. 1 is a configuration diagram of an example of a wireless power transmission system according to the present disclosure. In FIG. 1, in a wireless power transmission system 1, a structure entirely surrounded by an electromagnetic wave shielding member 2 having appropriate conductivity is regarded as a resonator, and at least one power transmission unit 3 and at least one power reception unit 4 are provided inside thereof. That is, the wireless power transmission system 1 refers to an entirety of a structure that achieves wireless power transmission. Note that a shape of the structure is not limited to a rectangular parallelepiped shape, and may be, for example, a pentagonal prism shape in which a ZX-plane is a pentagon, a quadrangular prism shape in which the ZX-plane is a trapezoid, or a semi-cylindrical shape in which the ZX-plane is a semicircle.

The electromagnetic wave shielding member 2 is not particularly limited as long as the electromagnetic wave shielding member 2 has conductivity, but examples thereof preferably include metal materials such as copper, aluminum, iron, stainless steel and nickel. Other examples include conductive oxide materials such as zinc oxide, titanium oxide and indium tin oxide (ITO), graphite, an organic conductive material, and the like. These may be formed of a plurality of layers made of the above-mentioned materials. Further, an alloy or a mixture may be used as long as the alloy or the mixture has conductivity. In addition, the shape may be a plate shape, a mesh shape, a film shape, a porous shape, or the like as long as the electromagnetic wave shielding member 2 operates as an electromagnetic wave shielding member at a frequency at which power is supplied. Further, the electromagnetic wave shielding member 2 may be covered with an electromagnetic wave transmission material for the purpose of surface protection or the like. Note that electromagnetic wave shielding in the electromagnetic wave shielding member 2 only needs to be capable of shielding electromagnetic waves only at a frequency used for wireless power transmission. That is, usage is possible in which communication at a frequency different from the frequency for wireless power transmission is not shielded.

A configuration of the power transmission unit 3 will be described using FIG. 2. The power transmission unit 3 is composed of, for example, a power transmitter including a power transmission antenna mounting portion 5 and a power transmission antenna wiring line 6. It is preferable that the power transmission antenna mounting portion 5 be made of metal and be installed so as to be substantially perpendicular to a wall surface made of the electromagnetic wave shielding member 2. In addition, the power transmission antenna mounting portion 5 itself may function as a part of a power transmission antenna. The power transmission antenna mounting portion 5 is disposed so as not to be electrically in contact with the electromagnetic wave shielding member 2, extends through the electromagnetic wave shielding member 2, and is electrically connected to a power transmission circuit disposed outside the resonator (structure). At this time, a connection portion and the power transmission circuit may be connected via a connector such as a sub miniature type A (SMA) terminal as appropriate. Note that a matching circuit for adjusting impedance between the above power transmission circuit and the power transmission unit 3 may be installed either inside or outside the resonator.

The power transmission antenna wiring line 6 may be provided on a printed circuit board or the like, or the power transmission antenna mounting portion 5 may be bent to form a wiring line. The power transmission antenna wiring line 6 is preferably formed so as to be substantially horizontal with respect to the wall surface of the resonator made of the electromagnetic wave shielding member 2.

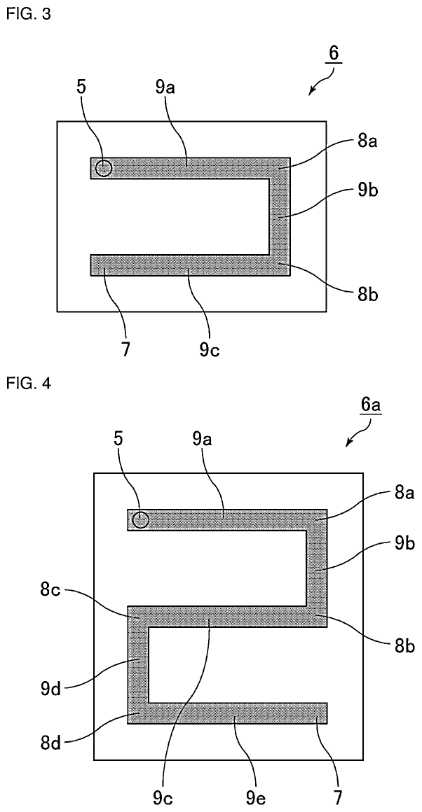

The structure of the power transmission antenna wiring line 6 will be described using FIG. 3. The power transmission antenna wiring line 6 has a wiring structure which has one end electrically connected to the power transmission antenna mounting portion 5 and another end that is an open end 7. The power transmission antenna wiring line 6 has bent portions in the above wiring structure. For example, the power transmission antenna wiring line 6 has two bent portions, namely, a first bent portion 8a and a second bent portion 8b, in order of closeness from a connection portion with the power transmission antenna mounting portion 5. As illustrated in FIG. 3, when each wiring section of the power transmission antenna wiring line 6 divided by the first bent portion 8a and the second bent portion 8b is focused, for example, a first power transmission antenna wiring portion 9a, a second power transmission antenna wiring portion 9b and a third power transmission antenna wiring portion 9c are defined. The power transmission antenna wiring line 6 has a structure in which, when viewed in a direction perpendicular to a direction in which the wiring sections divided by the bent portions extend, a wiring section and another wiring section present on the same wiring line are parallel to each other at facing positions as in a relationship between the first power transmission antenna wiring portion 9a and the third power transmission antenna wiring portion 9c. In this case, when observed along a path of the power transmission antenna wiring line 6 from the connection portion between the power transmission antenna wiring line 6 and the power transmission antenna mounting portion 5 to the open end 7, paths of the wiring sections parallel to each other at the facing positions are opposite to each other.

The power transmission unit 3 may include the power transmission antenna wiring line 6a illustrated in FIG. 4 instead of the power transmission antenna wiring line 6. The power transmission antenna wiring line 6a has four bent portions, namely, the first bent portion 8a, the second bent portion 8b, a third bent portion 8c and a fourth bent portion 8d, in order of closeness from a connection portion with the power transmission antenna mounting portion 5, and also has the first power transmission antenna wiring portion 9a, the second power transmission antenna wiring portion 9b, the third power transmission antenna wiring portion 9c, a fourth power transmission antenna wiring portion 9d and a fifth power transmission antenna wiring portion 9e which are wiring sections divided by the bent portions. The first power transmission antenna wiring portion 9a and the third power transmission antenna wiring portion 9c are parallel to each other at facing positions when viewed in a direction perpendicular to a direction in which the wiring sections divided by the bent portions extend, and paths of the wiring sections are opposite to each other when observed along a path of the power transmission antenna wiring line 6a from the connection portion between the power transmission antenna wiring line 6a and the power transmission antenna mounting portion 5 to the open end 7. Similarly, the third power transmission antenna wiring portion 9c and the fifth power transmission antenna wiring portion 9e are parallel to each other at facing positions when viewed in a direction perpendicular to a direction in which the wiring sections divided by the bent portions extend, and paths of the wiring sections are opposite to each other when observed along a path of the power transmission antenna wiring line 6a from the connection portion between the power transmission antenna wiring line 6a and the power transmission antenna mounting portion 5 to the open end 7. On the other hand, since the first power transmission antenna wiring portion 9a and the fifth power transmission antenna wiring portion 9e are parallel to each other but are not located so as to face each other, paths of the wiring sections do not need to be opposite to each other. Similarly, since the second power transmission antenna wiring portion 9b and the fourth power transmission antenna wiring portion 9d are parallel to each other but are not located so as to face each other, paths of the wiring sections do not need to be opposite to each other.

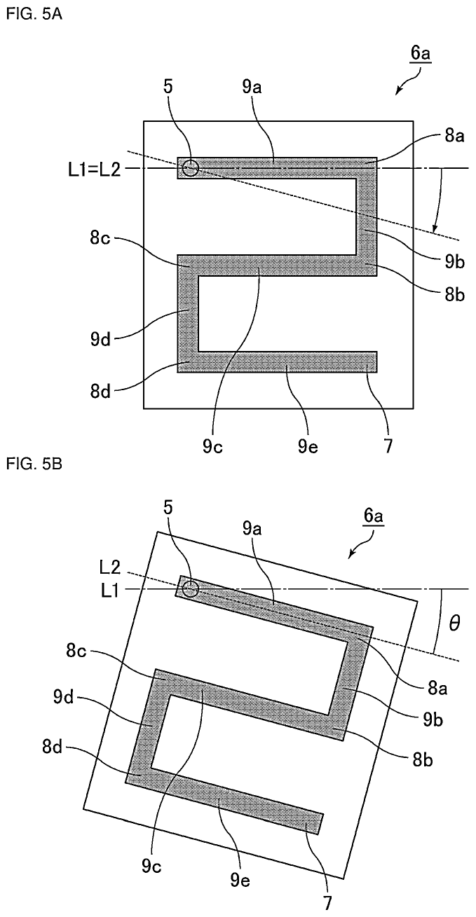

When the power transmission unit 3 includes, for example, the power transmission antenna wiring line 6a, the power transmission antenna wiring line 6a may have a structure in which the power transmission antenna wiring line 6a is rotated about the power transmission antenna mounting portion 5 as illustrated in FIG. 5A and FIG. 5B. When the power transmission antenna wiring line 6a is viewed from an inside of the structure, as illustrated in FIG. 5B, and when an angle formed by a first straight line L1 parallel to a floor surface of the structure and a second straight line L2 passing through the connection portion with the power transmission antenna mounting portion 5 and the first bent portion 8a closest to the connection portion is defined as θ, the angle θ preferably satisfies 0°≤θ≤90° or 180° ≤θ≤270°, and more preferably satisfies 0°≤θ≤60° or 180°≤θ≤240°.

Additionally, as illustrated in FIG. 5A, a wiring section of the power transmission antenna wiring line 6a from the connection portion with the power transmission antenna mounting portion 5 to the first bent portion 8a closest to the connection portion (that is, the first power transmission antenna wiring portion 9a) may be parallel to any wall surface of wall surfaces of the structure other than a wall surface on which the power transmission antenna mounting portion 5 is installed, and a wiring section of the power transmission antenna wiring line 6a from the first bent portion 8a to the second bent portion 8b closest to the connection portion after the first bent portion 8a (that is, the second power transmission antenna wiring portion 9b) may be parallel to any wall surface of the wall surfaces of the structure other than the wall surface on which the power transmission antenna mounting portion 5 is installed and the wall surface parallel to the first power transmission antenna wiring portion 9a.

In the power transmission unit 3, the number of bent portions included in the power transmission antenna wiring line is preferably equal to or greater than four and equal to or less than eight (i.e., from four to eight).

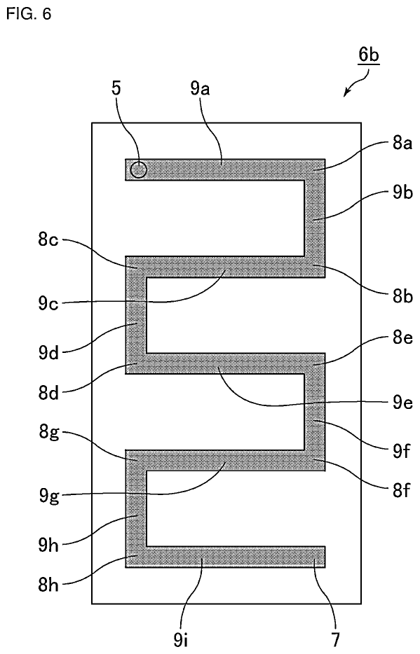

The power transmission antenna wiring line 6b illustrated in FIG. 6 has eight bent portions, namely, the first bent portion 8a, the second bent portion 8b, the third bent portion 8c, the fourth bent portion 8d, a fifth bent portion 8e, a sixth bent portion 8f, a seventh bent portion 8g and an eighth bent portion 8h, in order of closeness from a connection portion with the power transmission antenna mounting portion 5, and has the first power transmission antenna wiring portion 9a, the second power transmission antenna wiring portion 9b, the third power transmission antenna wiring portion 9c, the fourth power transmission antenna wiring portion 9d, a fifth power transmission antenna wiring portion 9e, a sixth power transmission antenna wiring portion 9f, a seventh power transmission antenna wiring portion 9g, an eighth power transmission antenna wiring portion 9h and a ninth power transmission antenna wiring portion 9i which are wiring sections divided by the bent portions. The first power transmission antenna wiring portion 9a and the third power transmission antenna wiring portion 9c are parallel to each other at facing positions when viewed in a direction perpendicular to a direction in which the wiring sections divided by the bent portions extend, and paths of the wiring sections are opposite to each other when observed along a path of the power transmission antenna wiring line 6b from the connection portion between the power transmission antenna wiring line 6b and the power transmission antenna mounting portion 5 to the open end 7. Similarly, when each of pairs of the third power transmission antenna wiring portion 9c and the fifth power transmission antenna wiring portion 9e, the fifth power transmission antenna wiring portion 9e and the seventh power transmission antenna wiring portion 9g, and the seventh power transmission antenna wiring portion 9g and the ninth power transmission antenna wiring portions 9i is viewed in a direction perpendicular to a direction in which the wiring sections divided by the bent portions extend, the power transmission antenna wiring portions of each pair are parallel to each other at facing positions, and paths of the wiring sections are opposite to each other when observed along a path of the power transmission antenna wiring line 6b from the connection portion between the power transmission antenna wiring line 6b and the power transmission antenna mounting portion 5 to the open end 7.

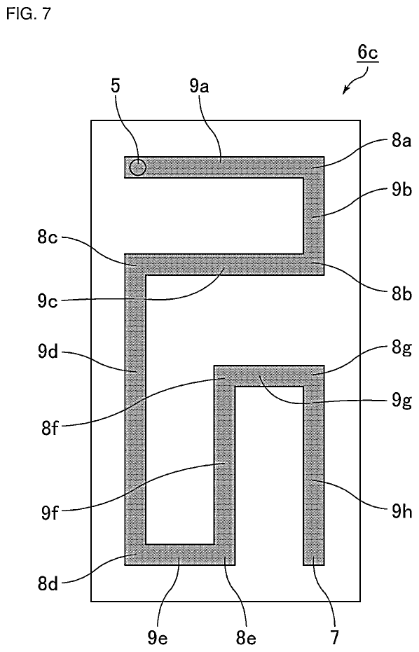

The power transmission antenna wiring line 6c illustrated in FIG. 7 has seven bent portions, namely, the first bent portion 8a, the second bent portion 8b, the third bent portion 8c, the fourth bent portion 8d, the fifth bent portion 8e, the sixth bent portion 8f and the seventh bent portion 8g, in order of closeness from a connection portion with the power transmission antenna mounting portion 5, and has the first power transmission antenna wiring portion 9a, the second power transmission antenna wiring portion 9b, the third power transmission antenna wiring portion 9c, the fourth power transmission antenna wiring portion 9d, the fifth power transmission antenna wiring portion 9e, the sixth power transmission antenna wiring portion 9f, the seventh power transmission antenna wiring portion 9g and the eighth power transmission antenna wiring portion 9h which are wiring sections divided by the bent portions. The first power transmission antenna wiring portion 9a and the third power transmission antenna wiring portion 9c are parallel to each other at facing positions when viewed in a direction perpendicular to a direction in which the wiring sections divided by the bent portions extend, and paths of the wiring sections are opposite to each other when observed along a path of the power transmission antenna wiring line 6c from the connection portion between the power transmission antenna wiring line 6c and the power transmission antenna mounting portion 5 to the open end 7. Similarly, the third power transmission antenna wiring portion 9c and the fifth power transmission antenna wiring portion 9e are parallel to each other at facing positions, and the third power transmission antenna wiring portion 9c and the seventh power transmission antenna wiring portion 9g are parallel to each other at facing positions, when viewed in a direction perpendicular to a direction in which the wiring sections divided by the bent portions extend, and paths of the wiring sections are opposite to each other when observed along a path of the power transmission antenna wiring line 6c from the connection portion between the power transmission antenna wiring line 6c and the power transmission antenna mounting portion 5 to the open end 7. Further, the fourth power transmission antenna wiring portion 9d and the sixth power transmission antenna wiring portion 9f are parallel to each other at facing positions, and the sixth power transmission antenna wiring portion 9f and the eighth power transmission antenna wiring portion 9h are parallel to each other at facing positions, when viewed in a direction perpendicular to a direction in which the wiring sections divided by the bent portions extend, and paths of the wiring sections are opposite to each other when observed along a path of the power transmission antenna wiring line 6c from the connection portion between the power transmission antenna wiring line 6c and the power transmission antenna mounting portion 5 to the open end 7.

In the power transmission unit 3, angles of the bent portions included in the power transmission antenna wiring line are not particularly limited, but are preferably substantially right angles. The angles of the bent portions may be the same or different from each other. Further, the bent portions may be rounded.

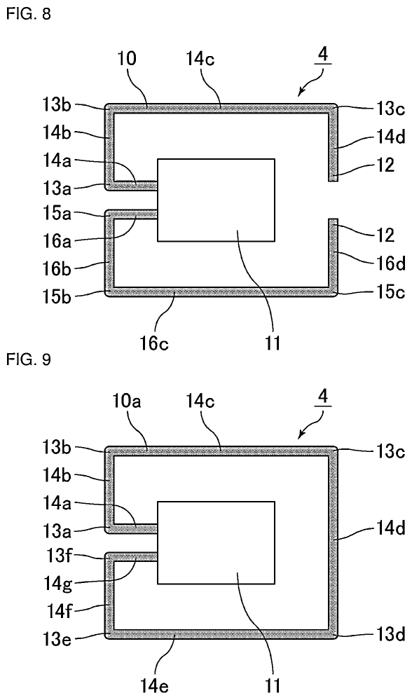

A configuration of the power reception unit 4 will be described using FIG. 8. The power reception unit 4 is composed of, for example, a power receiver including a power reception antenna wiring line 10 and a rectifier circuit 11. As appropriate, a switch, a matching circuit, and the like may be mounted. The power reception antenna wiring line 10 has a wiring structure of two lines which are formed in the same plane and each of which has one end connected to the rectifier circuit 11 and another end different from the one end connected to the rectifier circuit 11, the other ends thereof being open ends 12 disposed so as to face each other. The power reception antenna wiring line 10 has a plurality of bent portions in the wiring structure described above. For example, the power reception antenna wiring line 10 on one side has three bent portions, namely, a first bent portion 13a, a second bent portion 13b and a third bent portion 13c, in order of closeness from a connection portion with the rectifier circuit 11. As illustrated in FIG. 8, each of wiring sections of the power reception antenna wiring line 10 on the one side divided by the first bent portion 13a, the second bent portion 13b and the third bent portion 13c is focused, and for example, a first power reception antenna wiring portion 14a, a second power reception antenna wiring portion 14b, a third power reception antenna wiring portion 14c and a fourth power reception antenna wiring portion 14d are defined. Similarly, the power reception antenna wiring line 10 on another side has three bent portions, namely, a first bent portion 15a, a second bent portion 15b and a third bent portion 15c, in order of closeness from a connection portion with the rectifier circuit 11, and has a first power reception antenna wiring portion 16a, a second power reception antenna wiring portion 16b, a third power reception antenna wiring portion 16c and a fourth power reception antenna wiring portion 16d, which are wiring sections divided by the bent portions.

In the power reception antenna wiring line 10, when viewed in a direction perpendicular to a direction in which the wiring sections divided by the bent portions extend, in pairs of the first power reception antenna wiring portion 14a and the first power reception antenna wiring portion 16a, the second power reception antenna wiring portion 14b and the fourth power reception antenna wiring portion 14d, the third power reception antenna wiring portion 14c and the third power reception antenna wiring portion 16c, and the second power reception antenna wiring portion 16b and the fourth power reception antenna wiring portion 16d, the power reception antenna wiring portions of each pair face each other, and among them, the third power reception antenna wiring portion 14c and the third power reception antenna wiring portion 16c with a longest facing portion are parallel to each other. As described above, in the case where the power reception antenna wiring line has the wiring structure of the two lines, when viewed in a direction perpendicular to a direction in which the wiring sections divided by the bent portions extend, in three or more pairs of wiring sections, the wiring sections of each pair face each other, and among the wiring sections facing each other, the wiring sections with a longest facing portion are parallel to each other.

In the power reception antenna wiring line 10, among the wiring sections facing each other, wiring sections with a second longest facing portion are also preferably parallel to each other. That is, it is preferable that the second power reception antenna wiring portion 14b and the fourth power reception antenna wiring portion 14d be parallel to each other, or the second power reception antenna wiring portion 16b and the fourth power reception antenna wiring portion 16d be parallel to each other, or both be satisfied. Note that FIG. 8 illustrates that the second power reception antenna wiring portion 14b and the second power reception antenna wiring portion 16b have the same length and the fourth power reception antenna wiring portion 14d and the fourth power reception antenna wiring portion 16d have the same length, but the lengths of the second power reception antenna wiring portion 14b and the second power reception antenna wiring portion 16b may be the same or different from each other and the lengths of the fourth power reception antenna wiring portion 14d and the fourth power reception antenna wiring portion 16d may be the same or different from each other. When the lengths of the second power reception antenna wiring portion 14b and the second power reception antenna wiring portion 16b are different from each other and the lengths of the fourth power reception antenna wiring portion 14d and the fourth power reception antenna wiring portion 16d are different from each other, it is preferable that, among the wiring sections facing each other, wiring sections with a second longest facing portion be parallel to each other and additionally wiring sections with a third longest facing portion be also parallel to each other.

In the power reception antenna wiring line 10, when observed along a path of the power reception antenna wiring line 10 from the connection portion with the rectifier circuit 11 to the open end 12, among the wiring sections facing each other, wiring sections in which paths are opposite to each other are preferably parallel to each other.

The power reception unit 4 may include a power reception antenna wiring line 10a illustrated in FIG. 9 instead of the power reception antenna wiring line 10. The power reception antenna wiring line 10a has a loop-shaped wiring structure of one line which is formed in the same plane and which has both ends connected to the rectifier circuit 11. The power reception antenna wiring line 10a has a plurality of bent portions in the wiring structure described above. For example, the power reception antenna wiring line 10a has six bent portions, namely, the first bent portion 13a, the second bent portion 13b, the third bent portion 13c, a fourth bent portion 13d, a fifth bent portion 13e and a sixth bent portion 13f, from one connection portion with the rectifier circuit 11 toward another connection portion, and has the first power reception antenna wiring portion 14a, the second power reception antenna wiring portion 14b, the third power reception antenna wiring portion 14c, the fourth power reception antenna wiring portion 14d, a fifth power reception antenna wiring portion 14e, a sixth power reception antenna wiring portion 14f and a seventh power reception antenna wiring portion 14g which are wiring sections divided by the bent portions.

In the power reception antenna wiring line 10a, when viewed in a direction perpendicular to a direction in which the wiring sections divided by the bent portions extend, in pairs of the first power reception antenna wiring portion 14a and the seventh power reception antenna wiring portion 14g, the second power reception antenna wiring portion 14b and the fourth power reception antenna wiring portion 14d, the third power reception antenna wiring portion 14c and the fifth power reception antenna wiring portion 14e, and the fourth power reception antenna wiring portion 14d and the sixth power reception antenna wiring portion 14f, the power reception antenna wiring portions of each pair face each other, and among them, the third power reception antenna wiring portion 14c and the fifth power reception antenna wiring portion 14e with a longest facing portion are parallel to each other. As described above, also in the case where the power reception antenna wiring line has the wiring structure of the one line, when viewed in a direction perpendicular to a direction in which the wiring sections divided by the bent portions extend, in three or more pairs of wiring sections, the wiring sections of each pair face each other, and among the wiring sections facing each other, the wiring sections with a longest facing portion are parallel to each other.

In the power reception antenna wiring line 10a, among the wiring sections facing each other, wiring sections with a second longest facing portion are also preferably parallel to each other. That is, it is preferable that the second power reception antenna wiring portion 14b and the fourth power reception antenna wiring portion 14d be parallel to each other, or the fourth power reception antenna wiring portion 14d and the sixth power reception antenna wiring portion 14f be parallel to each other, or both be satisfied. Note that FIG. 9 illustrates that the second power reception antenna wiring portion 14b and the sixth power reception antenna wiring portion 14f have the same length, but the lengths of the second power reception antenna wiring portion 14b and the sixth power reception antenna wiring portion 14f may be the same or different from each other. When the lengths of the second power reception antenna wiring portion 14b and the sixth power reception antenna wiring portion 14f are different from each other, it is preferable that, among the wiring sections facing each other, wiring sections with a second longest facing portion be parallel to each other and additionally wiring sections with a third longest facing portion be also parallel to each other.

In the power reception antenna wiring line 10a, when observed along a path of the power reception antenna wiring line 10a from the one connection portion with the rectifier circuit 11 to the other connection portion, among the wiring sections facing each other, wiring sections in which paths are opposite to each other are preferably parallel to each other.

In the power reception unit 4, when a power reception antenna wiring line has a wiring structure of two lines, as illustrated in FIG. 8, and when the respective power reception antenna wiring line are viewed, it is preferable that the number of bent portions be the same and the number of pairs of wiring sections facing each other on the same wiring line be also the same. In this case, lengths of respective wiring sections in each of the power reception antenna wiring lines may be the same or different from each other.

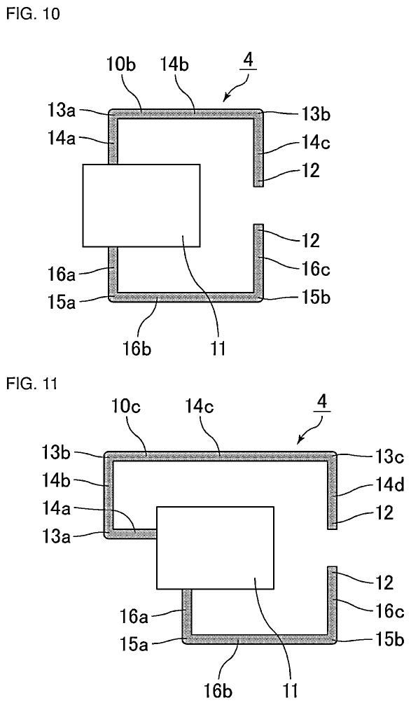

FIG. 10 is a schematic diagram of the power reception unit 4 including the power reception antenna wiring line 10b in which the number of bent portions is the same and the number of pairs of wiring sections facing each other on the same wiring line is also the same. The power reception antenna wiring line 10b on one side has two bent portions, namely, the first bent portion 13a and the second bent portion 13b, in order of closeness from a connection portion with the rectifier circuit 11, and has the first power reception antenna wiring portion 14a, the second power reception antenna wiring portion 14b and the third power reception antenna wiring portion 14c which are wiring sections divided by the bent portions. Similarly, the power reception antenna wiring line 10b on another side has two bent portions, namely, the first bent portion 15a and the second bent portion 15b, in order of closeness from the connection portion with the rectifier circuit 11, and has the first power reception antenna wiring portion 16a, the second power reception antenna wiring portion 16b and the third power reception antenna wiring portion 16c which are wiring sections divided by the bent portions.

In the power reception antenna wiring line 10b, when viewed in a direction perpendicular to a direction in which the wiring sections divided by the bent portions extend, in pairs of the first power reception antenna wiring portion 14a and the third power reception antenna wiring portion 14c, the second power reception antenna wiring portion 14b and the second power reception antenna wiring portion 16b, and the first power reception antenna wiring portion 16a and the third power reception antenna wiring portion 16c, the power reception antenna wiring portions of each pair face each other, and among them, the second power reception antenna wiring portion 14b and the second power reception antenna wiring portion 16b with a longest facing portion are parallel to each other. Accordingly, when viewed in the direction perpendicular to the direction in which the wiring sections divided by the bent portions extend, in three or more pairs of wiring sections, the wiring sections of each pair face each other, and among the wiring sections facing each other, the wiring sections with a longest facing portion are parallel to each other.

In the power reception antenna wiring line 10b, among the wiring sections facing each other, wiring sections with a second longest facing portion are also preferably parallel to each other. That is, it is preferable that the first power reception antenna wiring portion 14a and the third power reception antenna wiring portion 14c be parallel to each other, or the first power reception antenna wiring portion 16a and the third power reception antenna wiring portion 16c be parallel to each other, or both be satisfied. Note that FIG. 10 illustrates that the first power reception antenna wiring portion 14a and the first power reception antenna wiring portion 16a have the same length and the third power reception antenna wiring portion 14c and the third power reception antenna wiring portion 16c have the same length, but the lengths of the first power reception antenna wiring portion 14a and the first power reception antenna wiring portion 16a may be the same or different from each other and the lengths of the third power reception antenna wiring portion 14c and the third power reception antenna wiring portion 16c may be the same or different from each other. When the lengths of the first power reception antenna wiring portion 14a and the first power reception antenna wiring portion 16a are different from each other and the lengths of the third power reception antenna wiring portion 14c and the third power reception antenna wiring portion 16c are different from each other, it is preferable that, among the wiring sections facing each other, wiring sections with a second longest facing portion be parallel to each other and additionally wiring sections with a third longest facing portion be also parallel to each other.

In the power reception antenna wiring line 10b, when observed along a path of the power reception antenna wiring line 10b from the connection portion with the rectifier circuit 11 to the open end 12, among the wiring sections facing each other, wiring sections in which paths are opposite to each other are preferably parallel to each other.

In the power reception unit 4, when a power reception antenna wiring line has a wiring structure of two lines, and when the respective power reception antenna wiring lines are viewed, the number of bent portions may be different from each other and the number of pairs of wiring sections facing each other on the same wiring line may be different from each other.

FIG. 11 is a schematic diagram of the power reception unit 4 including the power reception antenna wiring line 10c in which the number of bent portions is different from each other and the number of pairs of wiring sections facing each other on the same wiring line is also different from each other. The power reception antenna wiring line 10c on one side has three bent portions, namely, the first bent portion 13a, the second bent portion 13b and the third bent portion 13c, in order of closeness from a connection portion with the rectifier circuit 11, and has the first power reception antenna wiring portion 14a, the second power reception antenna wiring portion 14b, the third power reception antenna wiring portion 14c and the fourth power reception antenna wiring portion 14d, which are wiring sections divided by the bent portions. The power reception antenna wiring line 10c on another side has two bent portions, namely, the first bent portion 15a and the second bent portion 15b, in order of closeness from the connection portion with the rectifier circuit 11, and has the first power reception antenna wiring portion 16a, the second power reception antenna wiring portion 16b and the third power reception antenna wiring portion 16c, which are wiring sections divided by the bent portions.

In the power reception antenna wiring line 10c, when viewed in a direction perpendicular to a direction in which the wiring sections divided by the bent portions extend, in pairs of the first power reception antenna wiring portion 14a and the third power reception antenna wiring portion 14c, the second power reception antenna wiring portion 14b and the fourth power reception antenna wiring portion 14d, the third power reception antenna wiring portion 14c and the second power reception antenna wiring portion 16b, and the first power reception antenna wiring portion 16a and the third power reception antenna wiring portion 16c, the power reception antenna wiring portions of each pair face each other, and among them, the third power reception antenna wiring portion 14c and the second power reception antenna wiring portion 16b with a longest facing portion are parallel to each other. Accordingly, when viewed in the direction perpendicular to the direction in which the wiring sections divided by the bent portions extend, in three or more pairs of wiring sections, the wiring sections of each pair face each other, and among the wiring sections facing each other, the wiring sections with a longest facing portion are parallel to each other.

In the power reception antenna wiring line 10c, among the wiring sections facing each other, wiring sections with a second longest facing portion are also preferably parallel to each other. That is, it is preferable that the second power reception antenna wiring portion 14b and the fourth power reception antenna wiring portion 14d be parallel to each other, or the first power reception antenna wiring portion 16a and the third power reception antenna wiring portion 16c be parallel to each other, or both be satisfied. Note that in FIG. 11 illustrates that the fourth power reception antenna wiring portion 14d and the third power reception antenna wiring portion 16c have the same length, and lengths of portions at which the second power reception antenna wiring portion 14b and the fourth power reception antenna wiring portion 14d face each other are the same as lengths of portions at which the first power reception antenna wiring portion 16a and the third power reception antenna wiring portion 16c face each other, but the lengths of the fourth power reception antenna wiring portion 14d and the third power reception antenna wiring portion 16c may be the same or different from each other. When the lengths of the fourth power reception antenna wiring portion 14d and the third power reception antenna wiring portion 16c are different from each other, it is preferable that, among the wiring sections facing each other, wiring sections with a second longest facing portion be parallel to each other and additionally wiring sections with a third longest facing portion be also parallel to each other.

In the power reception antenna wiring line 10c, when observed along a path of the power reception antenna wiring line 10c from the connection portion with the rectifier circuit 11 to the open end 12, among the wiring sections facing each other, wiring sections in which paths are opposite to each other are preferably parallel to each other.

In the power reception unit 4, when a power reception antenna wiring line has a wiring structure of one line, as illustrated in FIG. 9, and when the power reception antenna wiring line is viewed as being divided into two parts, it is preferable that the number of bent portions be the same and the number of pairs of wiring sections facing each other on the same wiring line be also the same. In this case, lengths of respective wiring sections in each of the power reception antenna wiring lines may be the same or different from each other. Further, when the power reception antenna wiring line is viewed as being divided into two parts, the number of bent portions may be different from each other and the number of pairs of wiring sections facing each other on the same wiring line may also be different from each other.

In the power reception unit 4, angles of the bent portions included in the power reception antenna wiring line are not particularly limited, but are preferably substantially right angles. The angles of the bent portions may be the same or different from each other. Further, the bent portions may be rounded.

By designing the antennas of the power transmission unit 3 and the power reception unit 4 as described above, it is possible to achieve a wireless power transmission system in which a power receiver is thin and has a high degree of freedom in installation orientation.

Since the wireless power transmission system 1 has a space shielded by the electromagnetic wave shielding member 2, the wireless power transmission system 1 can be considered as a resonator. When lengths in a horizontal direction of a resonator are a (in an X-axis direction) and b (in a Y-axis direction) and a length in a vertical direction is c (in a Z-axis direction), a resonant frequency f r can be determined as in Equation 1.

fᵣ=v/(2π×(μᵣ×εᵣ)^{1/2})×{(mπ/a)²+(nπ/b)²+(pπ/c)²}^{1/2} [Equation 1]

Here, v is the speed of light, μᵣ is a relative permeability, εᵣ is a relative dielectric constant, and m, n and p are integers.

The wireless power transmission system of the present disclosure is not limited to the above-described embodiment, and various applications and modifications can be made within the scope of the present disclosure.

### EXAMPLES

Hereinafter, examples that more specifically disclose the wireless power transmission system of the present disclosure will be described. Note that the present disclosure is not limited to these examples.

### Example 1

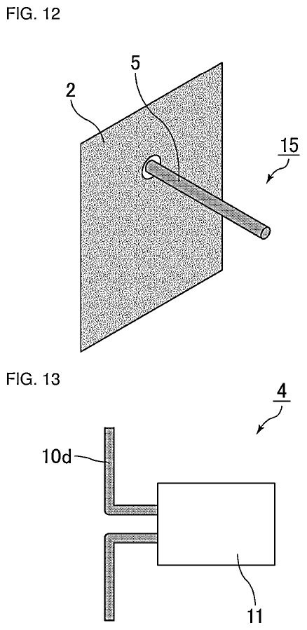

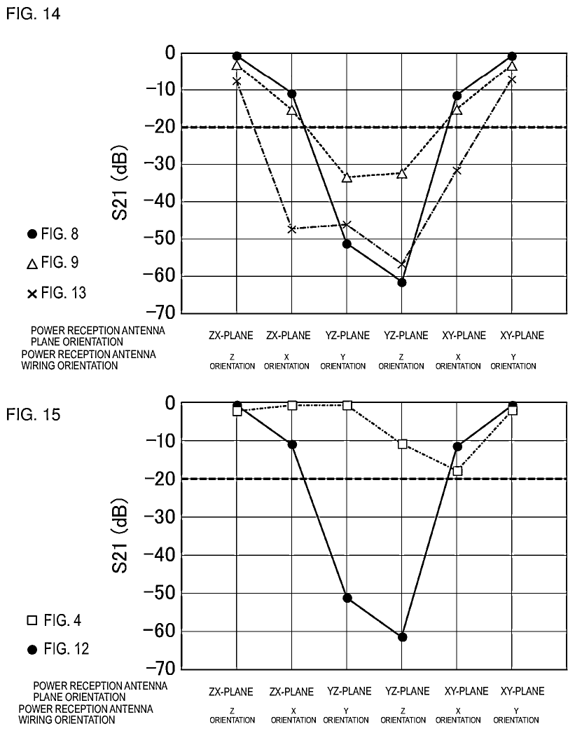

In Example 1, the wireless power transmission system 1 illustrated in FIG. 1 is considered, which is composed of the power transmission unit 3, the power reception unit 4 and a resonator (structure) formed of an electromagnetic wave shielding member 2 formed by an aluminum plate and an aluminum frame. However, the power transmission unit 15 illustrated in FIG. 12 was installed instead of the power transmission unit 3.

The resonator used for the wireless power transmission system according to Example 1 of the present disclosure has a rectangular parallelepiped shape in which a length in the X-axis direction is 880 mm, a length in the Y-axis direction is 540 mm, and a length in the Z-axis direction is 720 mm. The power transmission unit 15 is installed at a substantially central portion of a YZ-plane. Further, the power reception unit 4 is installed at a central position of the resonator.

FIG. 12 is a schematic diagram of the power transmission unit 15 according to Example 1 of the present disclosure. The power transmission unit 15 illustrated in FIG. 12 has a structure that does not have the power transmission antenna wiring line 6, and is substantially a monopole antenna structure.

As the power reception unit 4, three types of structure, namely, the power reception antenna wiring line 10 illustrated in FIG. 8, the power reception antenna wiring line 10a illustrated in FIG. 9 and the power reception antenna wiring line 10d illustrated in FIG. 13, were examined. A power reception antenna wiring structure illustrated in FIG. 13 is a so-called dipole antenna structure.

Here, a plane forming the power reception antenna wiring line 10, 10a, or 10d is defined as a power reception antenna plane orientation, and a direction in which the power reception antenna wiring line 10, 10a, or 10d extends from the rectifier circuit 11 is defined as a power reception antenna wiring orientation. For example, in the power reception unit 4 illustrated in FIG. 8, FIG. 9, and FIG. 13, the power reception antenna plane orientation is a direction parallel to the page, and the power reception antenna wiring orientation is a left-right direction. In the wireless power transmission system 1 prepared as described above, the bandpass characteristics S21 between the power transmission unit 15 and the power reception unit 4 were analyzed using analysis simulation software Femtet (registered trademark).

FIG. 14 shows a relationship between the bandpass characteristics S21 and the power reception antenna plane orientation and the power reception antenna wiring orientation in the wireless power transmission system according to Example 1 of the present disclosure. In order to drive an IOT device or charge a battery for the IOT device, it is desirable that the wireless power transmission efficiency be equal to or greater than 1%, that is, S21 be equal to or greater than −20 dB. It can be understood from FIG. 14 that, in the power reception antenna wiring structures illustrated in FIG. 8 and FIG. 9, when power reception antenna plane orientation/power reception antenna wiring orientation is ZX-plane/Z orientation, ZX-plane/X orientation, XY-plane/X orientation or XY-plane/Y orientation, the above-described S21 characteristics are satisfied. On the other hand, for the shape in FIG. 13 having the dipole antenna structure, it is understood that only ZX-plane/Z-orientation and XY-plane/Y-orientation satisfy the desired S21 characteristics.

As described above, it was found that by using the power reception unit 4 having the structure of the power reception antenna wiring line as illustrated in FIG. 8 or FIG. 9, it is not necessary to use a three-dimensional wiring structure, which is the problem of Non Patent Document 1 or Japanese Unexamined Patent Application Publication No. 2020-089209, and at the same time, an advantage of increasing power reception allowable orientations can be obtained.

### Example 2

In Example 2, the wireless power transmission system 1 is considered in which the power reception unit 4 having the structure illustrated in FIG. 8 is installed at a center of the same resonator as that of Example 1, and the power transmission unit 3 having the power transmission antenna wiring line 6a illustrated in FIG. 4 or the power transmission unit 15 having the monopole antenna structure illustrated in FIG. 12 is mounted.

In the wireless power transmission system 1 prepared as described above, the bandpass characteristics S21 between the power transmission unit 3 or 15 and the power reception unit 4 were analyzed using the analysis simulation software Femtet (registered trademark).

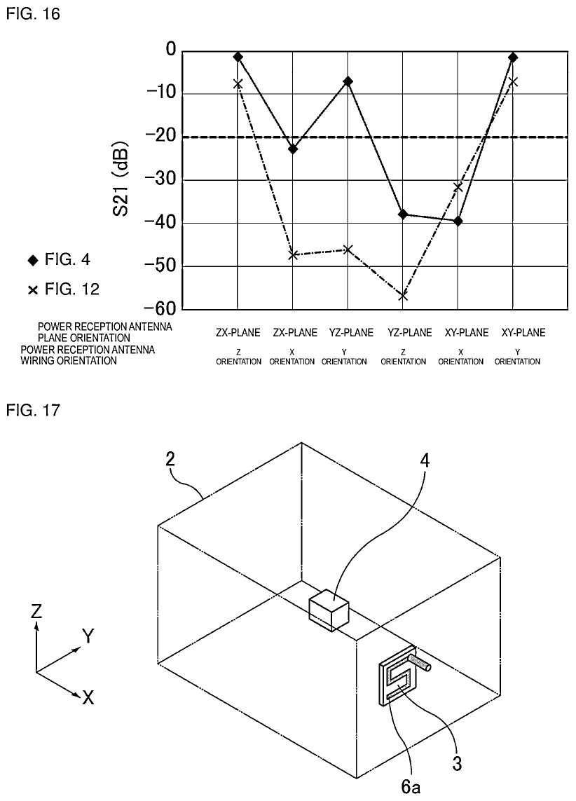

FIG. 15 shows a relationship between the bandpass characteristics S21 and power reception antenna plane orientation and power reception antenna wiring orientation in the wireless power transmission system according to Example 2 of the present disclosure. From FIG. 15, in the wireless power transmission system in which the monopole-type power transmission unit 15 illustrated in FIG. 12 is used, S21 is equal to or greater than −20 dB when the power reception antenna plane orientation/power reception antenna wiring orientation is ZX-plane/Z orientation, ZX-plane/X orientation, XY-plane/X orientation or XY-plane/Y orientation, whereas in the wireless power transmission system in which the power transmission unit 3 having an S-shape illustrated in FIG. 4 is used, S21 is equal to or greater than −20 dB in ZX-plane/Z orientation, ZX-plane/X orientation, YZ-plane/Y orientation, YZ-plane/Z orientation, XY-plane/X orientation or XY-plane/Y orientation.

As described above, it was found that the degree of freedom in installation orientation of the power receiver is further increased by using the power transmission unit 3 having the structure of the power transmission antenna wiring line as illustrated in FIG. 4.

### Example 3

In Example 3, the bandpass characteristics S21 were analyzed by a method similar to that in Example 2 except that the number of bent portions of the power transmission antenna wiring line was changed in a range from 0 to 12. Note that a case where the number of bent portions is four corresponds to Example 2.

Table 1 shows a relationship between the number of bent portions of the power transmission antenna wiring line and the bandpass characteristics S21. In Table 1, conditions under which S21 was equal to or greater than −20 dB, which is practically usable, are indicated by an asterisk. From the results shown in Table 1, it was made clear that the preferable number of bent portions is equal to or greater than 4 and equal to or less than 8 (i.e., from 4 to 8).

TABLE 1

| | Power | | | | | | | | | | | | | |
|---|---|---|---|---|---|---|---|---|---|---|---|---|---|---|
| Power | reception | | | | | | | | | | | | | |
| reception | antenna | | | | | | | | | | | | | |
| antenna | wiring | Number of bent portions | | | | | | | | | | | | |
| plane | orientation | 0 | 1 | 2 | 3 | 4 | 5 | 6 | 7 | 8 | 9 | 10 | 11 | 12 |
| ZX | Z | −5.08* | −8.82* | −10.22* | −6.55* | −2.21* | −0.81* | −1.69* | −11.70* | −0.32* | −1.62* | −8.36* | −12.34* | −6.61* |
| ZX | X | −25.37 | −7.84* | −0.32* | −0.60* | −0.69* | −0.61* | −0.23* | −0.10* | −0.22* | −0.52* | −2.49* | −4.94* | −3.41* |
| YZ | Y | −43.91 | −7.83* | −0.88* | −0.95* | −0.67* | −0.60* | −0.16* | −0.10* | −0.24* | −0.64* | −2.64* | −5.01* | −3.32* |
| YZ | Z | −46.92 | −11.67* | −11.93* | −14.61* | −2.02* | −11.76* | −14.27* | −14.02* | −17.74* | −18.75* | −22.56 | −22.92 | −20.56 |
| XY | X | −25.09 | −36.37 | −34.03 | −24.67 | −17.87* | −15.80* | −9.69* | −16.20* | −15.19* | −21.84 | −34.60 | −37.22 | −24.51 |
| XY | Y | −5.03* | −10.29* | −11.37* | −6.77* | −2.02* | −0.48* | −2.30* | −19.82* | −0.32* | −1.88* | −8.71* | −13.20* | −1.34* |

### Example 4

Examples 1 to 3 show results of examination about an inside of the resonator. In the examination disclosed in Non Patent Document 2, results indicating that the wireless power transmission system does not operate outside the resonator were obtained. Thus, the conditions in Examples 1 and 2 excluding the electromagnetic wave shielding member were examined without changing the disposition of the power receiver and the power transmitter. As a result, it was made clear that wireless power transmission was impossible because resonance did not occur in either Example 1 or Example 2.

### Example 5

In Example 5, the wireless power transmission system 1 is considered in which the power reception unit 4 having the dipole antenna structure illustrated in FIG. 13 is installed at a center of the same resonator as that of Example 1, and the power transmission unit 3 having the power transmission antenna wiring line 6a illustrated in FIG. 4 or the power transmission unit 15 having the monopole antenna structure illustrated in FIG. 12 is mounted.

In the wireless power transmission system 1 prepared as described above, the bandpass characteristics S21 between the power transmission unit 3 or 15 and the power reception unit 4 were analyzed using the analysis simulation software Femtet (registered trademark).

FIG. 16 shows a relationship between the bandpass characteristics S21 and power reception antenna plane orientation and power reception antenna wiring orientation in the wireless power transmission system according to Example 5 of the present disclosure. From FIG. 16, it was found that even when the power reception unit 4 having the existing dipole antenna structure is used, the degree of freedom in installation orientation of the power receiver is increased by using the power transmission unit 3 having the structure of the power transmission antenna wiring line as illustrated in FIG. 4.

### Example 6

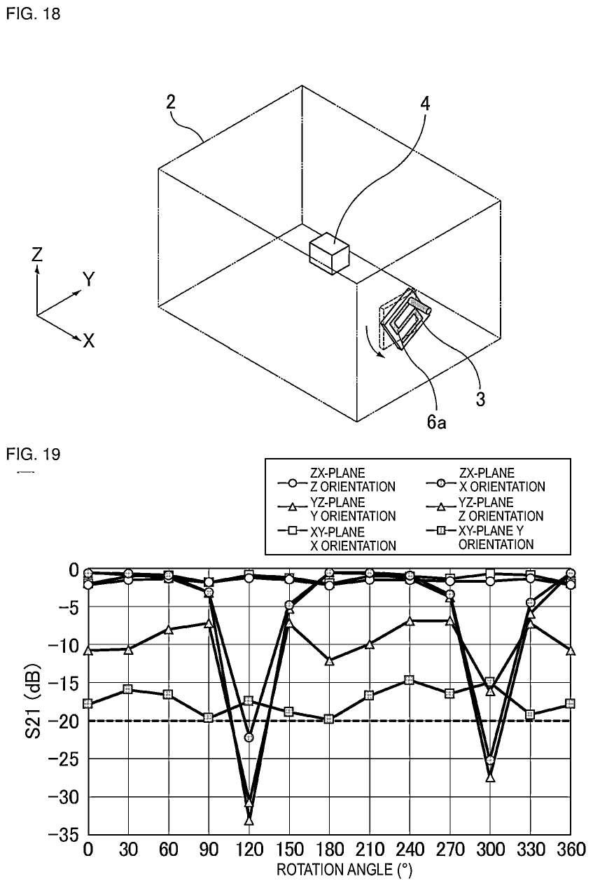

In Example 6, the bandpass characteristics S21 were analyzed by a method similar to that in Example 2 except that the power transmission antenna wiring line 6a constituting the power transmission unit 3 was rotated as illustrated in FIG. 17 and FIG. 18 to change the angle θ (see FIG. 5A and FIG. 5B) in a range from 0° to 360°. Note that a case where the angle θ is 0° or 360° corresponds to Example 2.

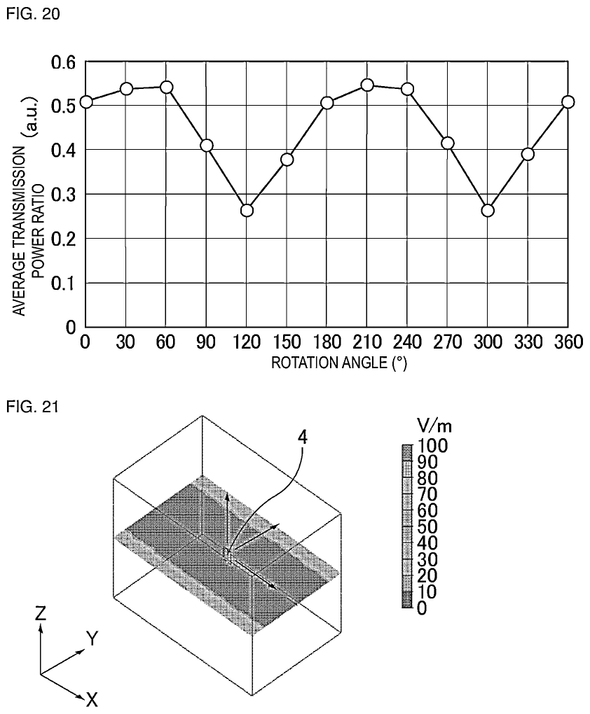

FIG. 19 shows a relationship between the rotation angle of the power transmission antenna wiring line with respect to respective installation orientations of a power receiver and the bandpass characteristics S21 in a wireless power transmission system according to Example 6 of the present disclosure. FIG. 20 shows a relationship between the average value of transmission power ratios in six directions shown in FIG. 19 and the rotation angle of the power transmission antenna wiring line. From FIG. 19, when the rotation angle of the power transmission antenna wiring line, that is, the angle θ of the power transmission antenna wiring line, satisfies 0°≤θ≤90° or 180°≤θ≤270°, the desired bandpass characteristics S21 are satisfied on all planes. Further, from FIG. 20, when the rotation angle of the power transmission antenna wiring line, that is, the angle θ of the power transmission antenna wiring line, satisfies 0°≤θ≤60° or 180°≤θ≤240°, the transmission power ratio can be set to equal to or greater than 0.5.

Thus, it was made clear that high power transmission efficiency can be obtained even when, as illustrated in FIG. 17, the first power transmission antenna wiring portion extending from the connection portion with the power transmission antenna mounting portion to the first bent portion is parallel to any wall surface of the wall surfaces of the structure other than the wall surface on which the power transmission antenna mounting portion is installed, and the second power transmission antenna wiring portion extending from the first bent portion to the second bent portion is parallel to any wall surface of the wall surfaces of the structure other than the wall surface on which the power transmission antenna mounting portion is installed and the wall surface parallel to the first power transmission antenna wiring portion.

### Example 7

FIG. 21 is a schematic diagram of an electric field intensity distribution in a wireless power transmission system according to Example 7 of the present disclosure. The resonator used for the wireless power transmission system according to Example 7 of the present disclosure has a rectangular parallelepiped shape in which a length in the X-axis direction is 500 mm, a length in the Y-axis direction is 600 mm, and a length in the Z-axis direction is 400 mm.

A center position in each of the X-axis direction, the Y-axis direction and the Z-axis direction was defined as 0, the bandpass characteristics S21 in a case where the power reception unit 4 was moved in any of the X-axis direction, the Y-axis direction and the Z-axis direction were analyzed using the analysis simulation software Femtet (registered trademark).

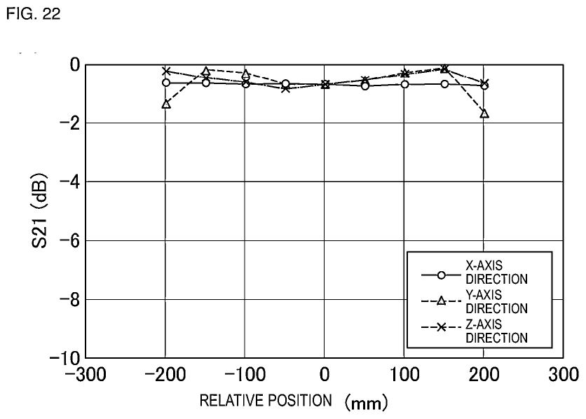

FIG. 22 shows a relationship between the relative position of the power reception unit and the bandpass characteristics S21 in the wireless power transmission system according to Example 7 of the present disclosure. From FIG. 22, when the electric field intensity at a place where the power reception unit is installed is high and the relative position of the power reception unit is in a range from −200 mm to +200 mm, S21 is equal to or greater than −2 dB, and it can be understood that wireless power transmission is possible regardless of the position of the power reception unit.

What is claimed is:

1. A wireless power transmission system comprising:
a structure entirely surrounded by an electromagnetic wave shielding member having appropriate conductivity, at least one power transmission unit, and at least one power reception unit,
wherein the power reception unit comprises a power receiver including a power reception antenna wiring line and a rectifier circuit,
the power reception antenna wiring line has a wiring structure of two lines which are in a same plane and each of which has one end connected to the rectifier circuit and another end different from the one end connected to the rectifier circuit, the other ends thereof being open ends which face each other, or a loop-shaped wiring structure of one line which is in a same plane and which has both ends connected to the rectifier circuit, the power reception antenna wiring line having a plurality of bent portions in either wiring structure,
when viewed in a direction perpendicular to a direction in which wiring sections divided by the bent portions extend, in three or more pairs of wiring sections, the wiring sections of each pair face each other,
among the wiring sections facing each other, wiring portions with a longest facing portion are parallel to each other, and
when the respective power reception antenna wiring lines are viewed, a number of bent portions is the same and a number of pairs of wiring sections facing each other on the same wiring line is also the same.

2. The wireless power transmission system according to claim 1, wherein
among the wiring sections facing each other, wiring sections with a second longest facing portion are also parallel to each other.

3. The wireless power transmission system according to claim 1, wherein
when the power reception antenna wiring line is viewed as being divided into two parts, the number of bent portions is the same and the number of pairs of wiring sections facing each other on the same wiring line is also the same.

4. The wireless power transmission system according to claim 2, wherein
when the power reception antenna wiring line is viewed as being divided into two parts, the number of bent portions is the same and the number of pairs of wiring sections facing each other on the same wiring line is also the same.

5. A wireless power transmission system comprising:
a structure entirely surrounded by an electromagnetic wave shielding member having appropriate conductivity, at least one power transmission unit, and at least one power reception unit,
wherein the power transmission unit comprises a power transmitter including a power transmission antenna mounting portion and a power transmission antenna wiring line,
the power transmission antenna mounting portion is out of electrical contact with the electromagnetic wave shielding member,
the power transmission antenna wiring line has a wiring structure which is inside the structure and parallel to a wall surface made of the electromagnetic wave shielding member and which has one end electrically connected to the power transmission antenna mounting portion and another end that is an open end, the power transmission antenna wiring line having from four to eight bent portions in the wiring structure,
when viewed in a direction perpendicular to a direction in which wiring sections divided by the bent portions extend, a wiring section and another wiring section present on the same wiring line are parallel to each other at facing positions, and
when observed along a path of the power transmission antenna wiring line from a connection portion with the power transmission antenna mounting portion to the open end, paths of the wiring sections parallel to each other at the facing positions are opposite to each other.

6. The wireless power transmission system according to claim 5, wherein
when the power transmission antenna wiring line is viewed from an inside of the structure, an angle θ defined by a first straight line parallel to a floor surface of the structure and a second straight line passing through the connection portion with the power transmission antenna mounting portion and a first bent portion closest to the connection portion satisfies 0°≤θ≤90° or 180°≤θ≤270°.

7. The wireless power transmission system according to claim 6, wherein the angle θ satisfies 0°≤θ≤60° or 180°≤θ≤240°.

8. The wireless power transmission system according to claim 5, wherein
a first power transmission antenna wiring portion which is a wiring section of the power transmission antenna wiring line from the connection portion with the power transmission antenna mounting portion to a first bent portion closest to the connection portion is parallel to any wall surface of wall surfaces of the structure other than a wall surface on which the power transmission antenna mounting portion is installed, and
a second power transmission antenna wiring portion which is a wiring section of the power transmission antenna wiring line from the first bent portion to a second bent portion closest to the connection portion after the first bent portion is parallel to any wall surface of the wall surfaces of the structure other than the wall surface on which the power transmission antenna mounting portion is installed and the wall surface parallel to the first power transmission antenna wiring portion.

9. The wireless power transmission system according to claim 6, wherein
a first power transmission antenna wiring portion which is a wiring section of the power transmission antenna wiring line from the connection portion with the power transmission antenna mounting portion to a first bent portion closest to the connection portion is parallel to any wall surface of wall surfaces of the structure other than a wall surface on which the power transmission antenna mounting portion is installed, and
a second power transmission antenna wiring portion which is a wiring section of the power transmission antenna wiring line from the first bent portion to a second bent portion closest to the connection portion after the first bent portion is parallel to any wall surface of the wall surfaces of the structure other than the wall surface on which the power transmission antenna mounting portion is installed and the wall surface parallel to the first power transmission antenna wiring portion.

10. The wireless power transmission system according to claim 7, wherein
a first power transmission antenna wiring portion which is a wiring section of the power transmission antenna wiring line from the connection portion with the power transmission antenna mounting portion to a first bent portion closest to the connection portion is parallel to any wall surface of wall surfaces of the structure other than a wall surface on which the power transmission antenna mounting portion is installed, and
a second power transmission antenna wiring portion which is a wiring section of the power transmission antenna wiring line from the first bent portion to a second bent portion closest to the connection portion after the first bent portion is parallel to any wall surface of the wall surfaces of the structure other than the wall surface on which the power transmission antenna mounting portion is installed and the wall surface parallel to the first power transmission antenna wiring portion.
